(19) United States
(12) Patent Application Publication
(10) Pub. No.: US 2009/0123784 A1
(43) Pub. Date: May 14, 2009

(54) FUEL CELL MODULE

(76) Inventors: Thomas J. Pavlik, Riviera Beach, FL (US); Hodge Rex, Riviera Beach, FL (US); Jeffrey R. Pierce, Palm Beach Shores, FL (US); James Braun, Boynton Beach, FL (US); Walter Pierce, III, Lake Worth, FL (US); Vesna Stanic, West Palm Beach, FL (US)

Correspondence Address: AKERMAN SENTERFITT, P.O. BOX 3188, WEST PALM BEACH, FL, 33402-3188, US

(21) Appl. No.: 12/210,726

(22) Filed: Sep. 15, 2008

Related U.S. Application Data
(60) Provisional application No. 60/993,586, filed on Sep. 13, 2007.

(51) Int. Cl. H01M 8/24

(52) U.S. Cl. 429/12

(57) ABSTRACT

The invention relates to the design and manufacturing of a symmetrical polymer electrolyte fuel cell (the cell module) having two cells arranged in mirror symmetry with respect to a central plane of a non conductive fuel manifold. The symmetrical dual cell configuration allows application of adhesive seals for the innermost fuel electrodes. These seals are formed by gluing two membrane electrode assemblies to the opposing faces of the central manifold. The cell module employed as an array of individual modules, or combined into planar or stacked fuel cell configurations.

### RELATED APPLICATIONS

This non-provisional patent application claims priority to a provisional patent application Ser. No. 60/993,586 filed on Sep. 13, 2007 and incorporated herewith by reference in its entirety.

### FIELD OF THE INVENTION

The subject invention relates to an electrochemical energy conversion device that can produce electrical power, water, and heat by combining fuel and oxidant and more particularly a polymer electrolyte membrane (PEM) fuel cell module.

### BACKGROUND OF THE INVENTION

Hydrogen fuel cells convert the chemical energy stored in hydrogen and oxygen into electricity, heat, and water. They were first invented by William Grove in 1893. Fuel cells employ an electrolyte disposed between two electrodes, namely a cathode and an anode. The electrodes generally comprise a porous, electrically conductive gas diffusion layer (GDL) material and an electrocatalyst disposed at the interface between the electrolyte and the electrode layers. The electrocatalyst enhances the electrochemical reactions: hydrogen oxidation and oxygen reduction reactions.

Polymer electrolyte membrane (PEM) fuel cells, also called the solid polymer fuel cells, typically employ a membrane electrode assembly (MEA) that include a proton exchange membrane as electrolyte disposed between two electrode layers. The membrane, in addition of being ion-conductive material, also is an electrical insulator and a physical barrier for reactants mix. The MEA is typically interposed between two electrically conductive plates. The plates act as current collectors, and provide also mechanical support to the MEA. The current collector plates may have channels, or openings in one or both plate surfaces to direct the fuel and oxidant to the respective electrode layers, namely the anode on the fuel side and the cathode on the oxidant side.

Typically fuel cells are assembled together in series into a fuel cell stacks to increase the overall output power. In series arrangement, one side of a plate may serve as cathode plate for the adjacent cell, with the current collector plate functioning as a bipolar plate with the other side functioning as the anode. Such a bipolar plate may have flow field channels formed on both active surfaces.

A fuel cell stack typically includes inlet ports and supply manifolds for directing the fuel and the oxidant to each fuel cell anode and cathode respectively. The stack often includes an inlet port and manifold for directing a coolant fluid to interior passages within the stack to absorb heat generated by the electrochemical reaction in the fuel cells. The stack also includes exhaust manifolds and outlet ports for expelling the non reacted fuel and oxidant, and water generated in the reaction. It may also have an exhaust manifold and outlet port for the coolant stream exiting the stack. The stack manifolds may be internal created through aligned openings formed in the separator layers and MEAs, or may have external or edge manifolds, attached to the edges of the separator layers.

Conventional fuel cell stacks are sealed to prevent leaks and internal mixing of fuel and oxidant. Fuel cell stacks typically employ fluid tight resilient seals, such as elastomeric gaskets between the separator plates and membranes. Such seals typically circumscribe the manifolds and the electrochemically active area. Sealing is achieved by applying a compressive force to the resilient gasket seals. To prevent the gasket from sagging into channels and restricting the fluid flow in manifold, the channels are frequently drilled just below the surface of current collector plates to stay covered with a thin, flat layer of the plate material that functions as a built-in manifold cover.

Fuel cell stacks are compressed to enhance sealing and electrical contact between the surfaces of the plates and the MEAs, and between adjoining plates. In conventional fuel cell stacks, the fuel cell plates and MEAs are typically compressed and maintained in their assembled state between a pair of end plates by metal tie rods or tension members. The tie rods typically extend internally or externally to the stack through holes formed in the stack end plates, and have associated nuts or other fastening means to secure them in the stack assembly.

To become commercially viable PEM fuel cell need to have competitive cost with the power generators currently available on the market. Additionally, for portable applications fuel cells must be lightweight and have small compact size to compete with batteries. The shortcomings of the current fuel cell technology that impede their commercialization, originate in the complexity of the design, the number of parts that results in costly production and assembly, and most significantly in the cost of materials used.

Sealing mechanisms used in the state-of the-art fuel cells significantly contribute to their size. Due to high compression force needed to achieve sealing, the end plates and current collector plates require relatively high structural strength. They are often made of metals or composite materials that give large weight and size to the fuel cell, making it not suitable for portable applications. Additionally, the fuel cell components must be made with very high thickness precision to avoid non uniform compression, a contributor to premature stack failure. This requirement leads to complex manufacturing procedures that increases fuel cell cost.

An attempt to resolve the problems encountered by compression sealing is disclosed in U.S. Pat. No. 6,783,883. Adhesive gluing of MEAs to bipolar plates is used to seal a single fuel cell. Adhesive even penetrates into the edges of gas diffusion layers (GDLs) forming gap-free seals that exist not only on the outer circumference of the GDL between bipolar plate and the MEA. However, internal manifolds in the stack increase the complexity of the assembly because adhesive is also applied around internal gas manifolds.

U.S. Pat. No. 6,946,210 describes an improvement which includes both adhesion sealing and simplified compression mechanism for maintaining the stack components in close contact. In this approach adhesive sealant is applied around manifold openings in MEA and bipolar plates. The peripheral edges of the MEAs and bipolar plates are then encapsulated together by a resin to make a multiple fuel cell cassette.

To simplify fuel cell stack manufacturing and assembly using the same sealing and encapsulation method, internal manifolds are eliminated and replaced with the external as explained in U.S. Pat. No. 7,052,796. Even though the new design eliminates deficiencies described in U.S. Pat. No. 6,946,210, it has increased manufacturing complexity since four small ports must be sealed by adhesive sealant externally to each fuel cell.

Another approach used to eliminate compression, simplify manufacturing, decrease cost and increase portability is described in patent application US 2007/0105008 A1. This applies lamination procedure where porous gas distribution layers and current collection layers are laminated over MEA and then glued together at the edge to a nonporous thin frame. However, the power output of this laminated fuel cell is extremely low (˜0.01 W/cm²).

In addition to a cassette approach previously described in U.S. Pat. No. 6,946,210 and U.S. Pat. No. 7,052,796, another improved modular approach is described in U.S. Pat. No. 6,030,718. To increase the stack power output and reliability, the individual fuel cell modules are mounted on a rack for delivering hydrogen. The modular design in this approach simplifies the stack assembly and disassembly; in the case that one or more modules malfunction, they can be easily replaced with the new ones. The fuel cell module described in this U.S. Pat. No. 6,030,718 has a hydrogen distribution frame with at least one pair of MEAs sealed to it on the opposing frame faces. However, the design described in this patent is very complex both at the system and fuel cell module levels. The gas delivery rack has fittings that must precisely mach the counter parts in the fuel cell module frame. Additionally, there is a complicated multi part compression system within the fuel cell module to keep the fuel cell components in electrical contact, and perhaps to provide the module sealing.

Another platform used for a modular approach is planar. In U.S. Pat. No. 6,127,058 the details of this design are disclosed. A planar fuel cell module is created by sandwiching a single sheet of a polymer electrolyte membrane with coated array of anodes and corresponding cathodes, between two current collector plates. A frame in the module forms a gas tight integral seal for a common hydrogen manifold of the unit cells. Likewise, the oxidant gas is distributed to the cells on the other side via common manifold or through current collectors in an open cathode design. The planar design may have limitations in power output due to the space availability in a device where it is used.

### SUMMARY OF THE INVENTION

The present invention provides a novel modular PEM fuel cell that has simplified design, assembly and manufacturing, and lower cost. In particular this invention provides a PEM fuel cell module having a symmetrical arrangement of two individual fuel cells with respect to a central single fuel manifold. In addition the module is assembled utilizing procedures that allow for a broad dimensional tolerance of the fuel cell components. The fuel cell module may have a passive supply of reactants through open structure anode and cathode plates, and may operate without active humidification, heating/cooling. It is a light-weight portable device that may generate minimum 0.1 W/cm² at room temperature and pressure.

Each module referred to in this invention as Sym-Cell, is an assembly of one fuel manifold, two membrane electrode assemblies (MEAs), and two pairs of anode and cathode current collector plates. The fuel manifold is a central component of the module with two fuel cells being built upon its faces. Anode plates attached to the manifold by gluing, support MEAs. The module assembly is completed by affixing cathode collector plates via bolts or some other means to the opposing faces of the module. The integration of a single manifold per two fuel cells improves the design of fuel cell by reducing its complexity and bulkiness thereby reducing the number of parts, and weight of fuel cell.

An advantage of this invention is to provide a single manifold for fuel supply to multiple fuel cells. A central manifold provides the fuel to the fuel cells through open structure anode current collector plates. Fuel is supplied and removed from Sym-Cell through an inlet and outlet incorporated into the manifold. External manifolding is used to supply and exhaust fuel from the module simplifying the complexity of module assembly.

Still another advantage of the current invention is to use open structure cathode to supply oxidant to the cathode electrodes in MEAs.

Still another advantage of the present invention is sealing of the fuel cell without compressive force. Sealing of the fuel manifold is achieved by gluing the anode plate and MEA to the fuel manifold. In particular this advantage allows for a usage of components with wider dimensional tolerance manufactured by simplified high production processes that may include molding, gluing, lamination, and cutting. The Sym-Cell module sealed by gluing is capable to accommodate anode manifold produced by casting or molding to the final dimensions in a single step process, as well as to use of shelf materials to make anode and cathode current collector plates at least by cutting. In addition, elimination of sealing by compression removes one of the potential reasons for a premature fuel cell failure.

Still another advantage of the invention is more reliable adhesive sealing of the fuel cell. The enhanced bonding is achieved by selecting adhesive sealant and manifold material to contain the same base polymer. The material compatibility at the bond interface improves the seal resistance to the mechanical and thermal stresses imposed by the operation of the fuel cell.

Still another advantage of the present invention is the simplified design of fuel cell that enables the usage of open structure conductive materials for multiple function plates thereby reducing number of parts. They are used as anode and cathode current collector plates, fuel and oxidant flow distribution plates, and fuel cell end plates that keep all the components in a single module assembly.

Still another advantage of the present invention is that the open structure conductive plates may be made as multi layer composites with improved corrosion resistance and electrical conductivity thereby reducing material and manufacturing cost of fuel cells. This is achieved by bonding thin layers of more electrically conductive and corrosion resistant material with a conductive adhesive to the open structure current collector plates made of inexpensive commercially available materials.

Still another advantage of this invention is the elimination of the interfacial resistance within Sym-Cell with small compressive force that provides the optimized electrical resistance within a single module thereby resulting in lighter and less complex fuel cells. In particular this advantage provides flexibility to arrange individual modules in various planar or 3-D stack configurations without the need for complex and heavy compression mechanism since a small compressive force is applied to the module by attaching the open structure cathode current collector plates in a final model assembly step.

Still another advantage of the invention is flexibility in increasing voltage or current within a power output of Sym-Cell by connecting two fuel cells of a single module in series or in parallel. In particular, the module's open circuit voltage is ˜2V when the fuel cells are connected in series and ˜1V when they are connected in parallel, while the power out put stays the same.

Still another advantage of the present invention is that Sym-Cell has the unconstrained design applicable to the wide range of operating conditions thereby being a universal platform for low cost PEM fuel cells. More specifically, Sym-Cell can be made to operate either as a low temperature PEM fuel cell, or as a high temperature PEM fuel cell depending on the selection of polymer electrolyte membrane in MEA, and materials of other components.

### BRIEF DESCRIPTION OF THE DRAWINGS

Other advantages of the present invention will be readily appreciated as the same becomes better understood by reference to the following detailed description when considered with the accompanying drawing herein:

FIG. 1 illustrates a side view of a single symmetrical cell module (the cell module) of the present invention;

FIG. 2 is an exploded view of the cell module of FIG. 1;

FIG. 3 is a side view of a central anode manifold of the cell module;

FIG. 4 presents a simplified design of the manifold;

FIG. 5 illustrates a perspective view of the central anode manifold shown in FIG. 3;

FIG. 6 is a fragmental view of the manifold design around the fluid inlet/outlet and fluid flow fields of FIG. 5;

FIG. 7 is a perspective view of the central anode manifold with two anode collector plates;

FIG. 8 is a top view of a five layer membrane electrode assembly (MEA);

FIG. 9 is top view of the central anode manifold with two anode collector plates shown in FIG. 7; and

FIG. 10 is a graph illustrating average polarization curve of the cell module operated with hydrogen and air at ambient temperature and pressure.

### DETAILED DESCRIPTION OF THE PREFERRED EMBODIMENT

Referring to the Figures, wherein like numerals indicate like or corresponding parts, an illumination or light device of the present invention is generally shown at 10. The invention encompasses a symmetrical PEM fuel cell module, Sym-Cell, which includes two fuel cells and single fuel manifold. This design allows wider dimensional tolerance and fewer number of the fuel cell components, resulting in simpler manufacturing and lower fuel cell cost. The Sym-Cell module is designed to have doubled power output per unit as compared to a single cell.

Sym-Cell module 1 of the present invention includes two individual polymer electrolyte fuel cells 9 arranged in mirror symmetry with respect to the central fuel manifold plate 2. Each PEM fuel cell 9 includes an anode current collector plate 3, membrane electrode assembly (MEA) 4, and cathode current collector plate 5. The module 2 is assembled on the opposing faces of the fuel manifold 2. Anode collector plates 3 and MEAs 4 are bonded to the fuel manifold 2 by adhesive first, and then the cathode collector plates 5 are attached to with bolts 6 and nuts 7 to complete the module 2 assembly.

Fuel, typically hydrogen, is supplied to and exhausted from two fuel cells 9 via inlet and outlet ports 18 located in the single fuel manifold 2. The open designs of the anode current collector plates 3 and cathode current collector plate 5 allow the transfer of fuel and oxidant, respectively, to and from the fuel cell 9 MEAs 4. The fuel cells 9 are electrically isolated with the manifold 2, non conductive washers 8a, and plastic shrink tubes 12 placed over the bolts 6 as shown in FIGS. l and 2.

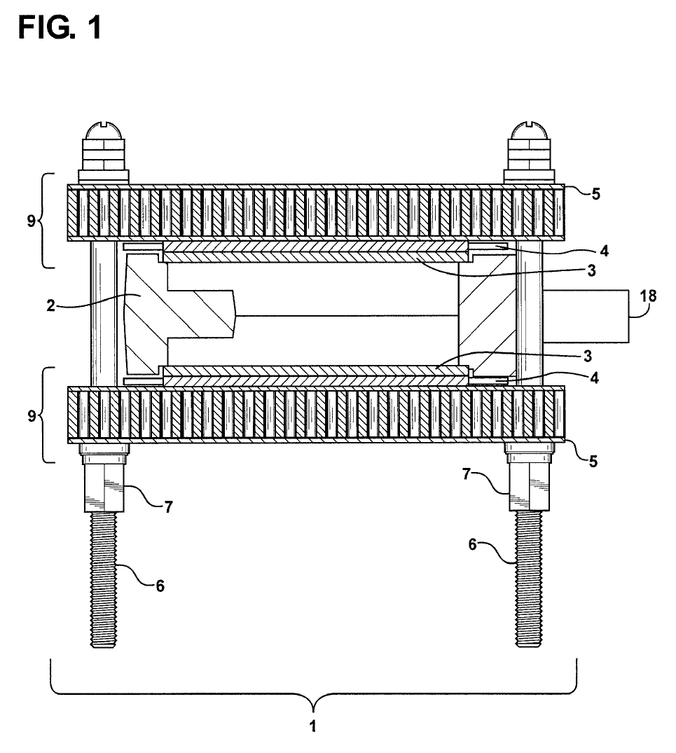

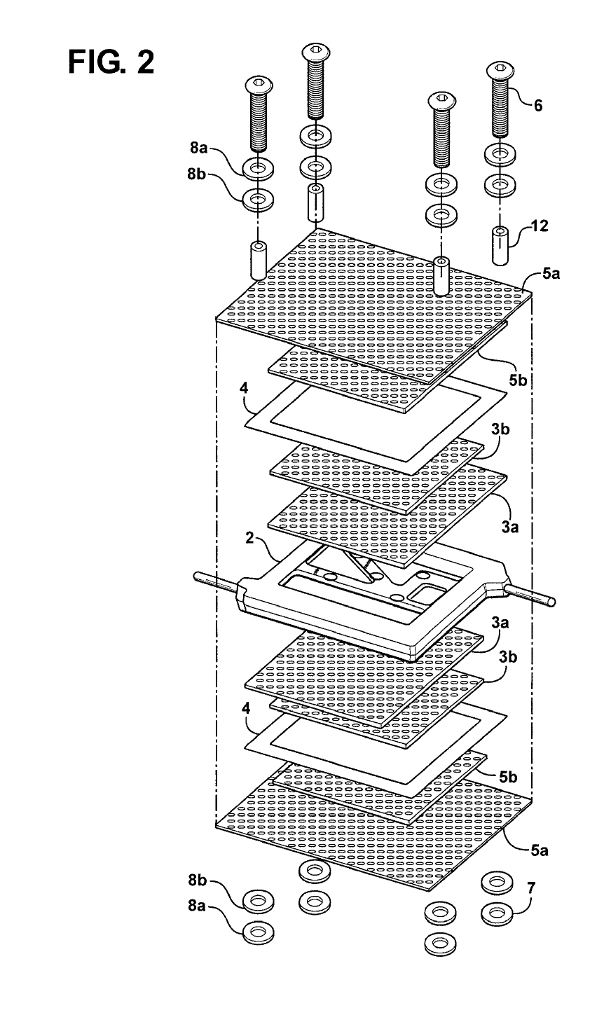

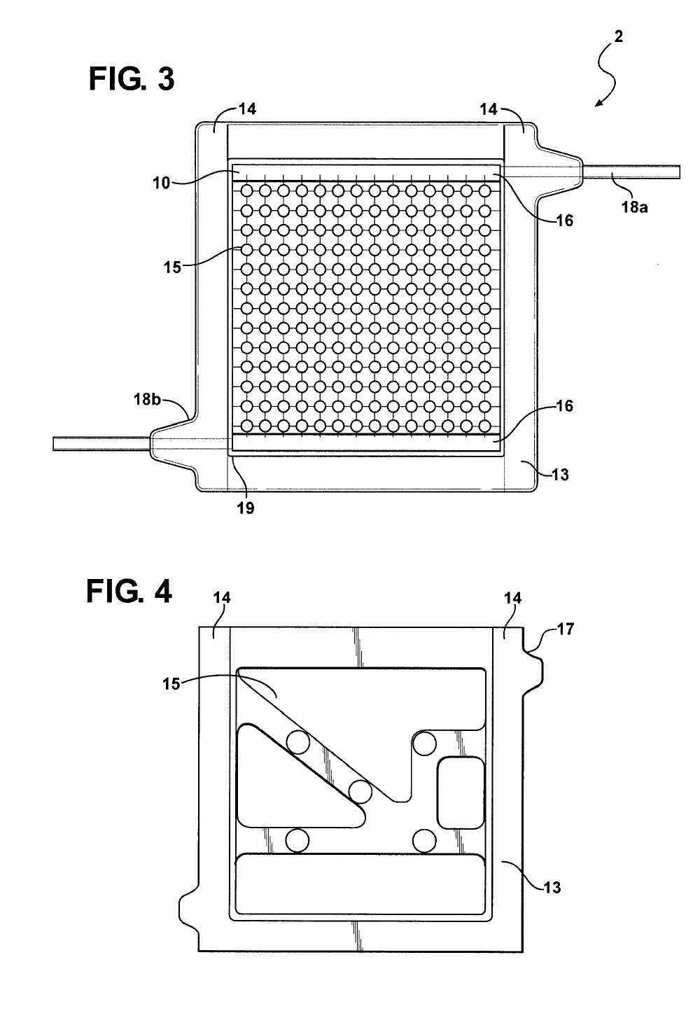

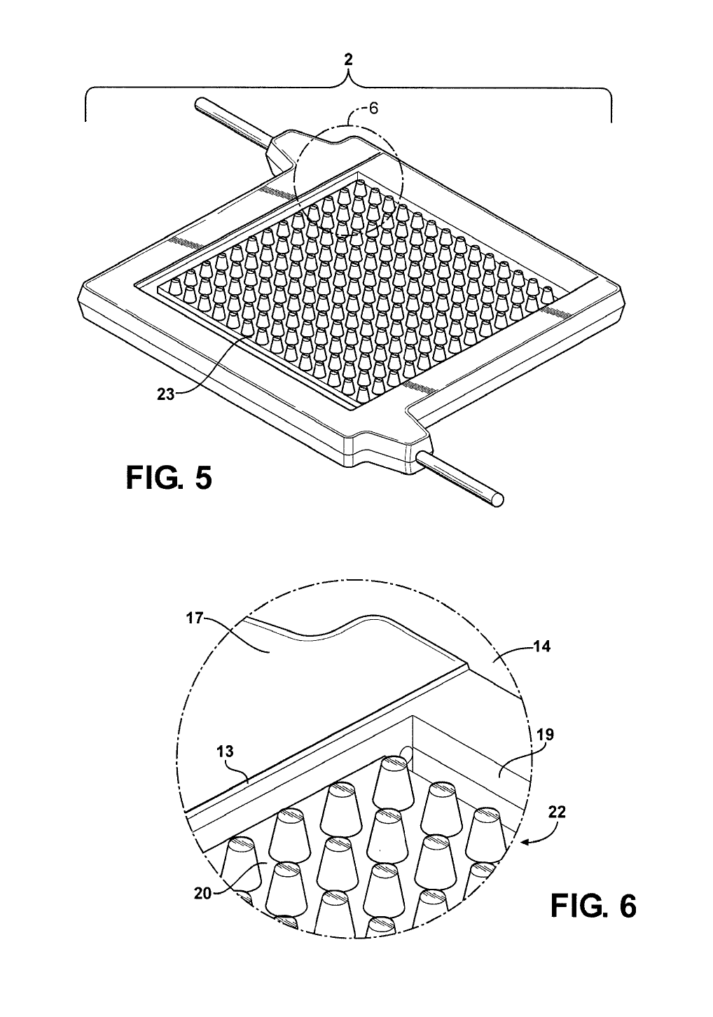

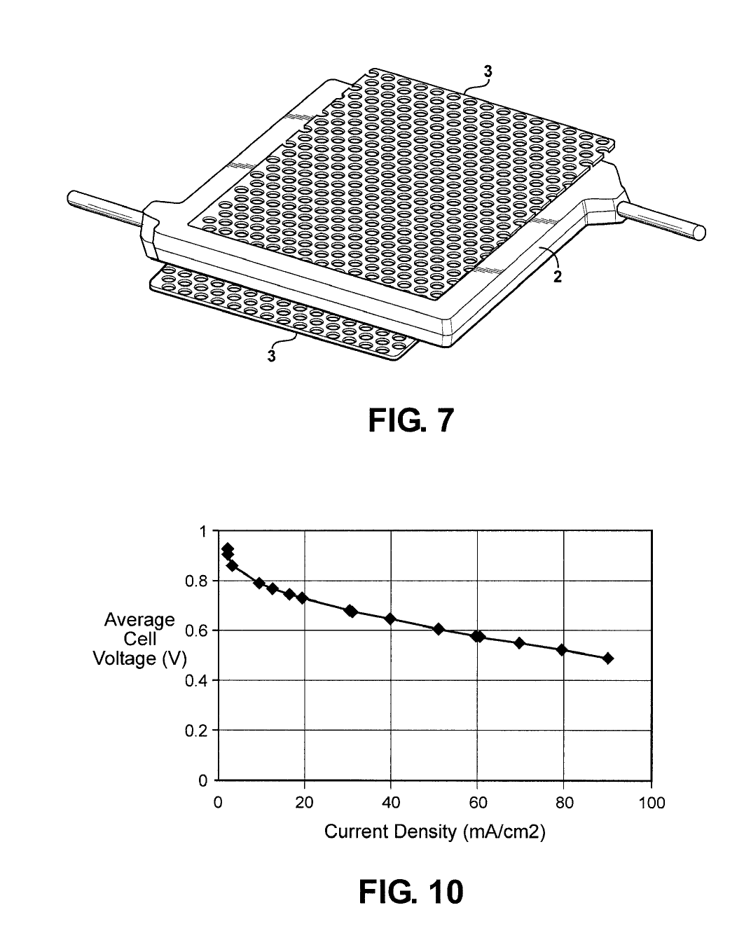

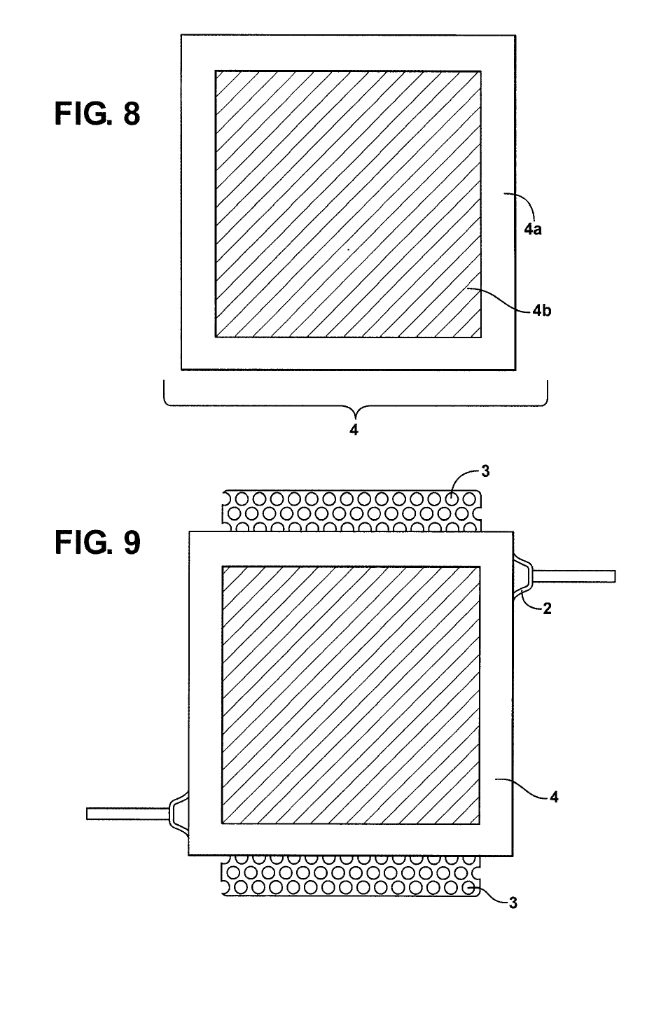

A central fuel manifold 2 introduces, distributes, and exhausts fuel with or without water vapor from the anode surfaces of two MEAs 4. In addition, it electrically insulates the fuel cells 9, as well as supports the adjacent fuel cell components mounted on its opposing faces. The fuel manifold 2 design is best shown in FIGS. 1 and 2. It is a plate that has flat surface 13 around perimeter along three sides and recess 14 at the fourth side on both opposing faces. Fuel flow fields 15 are located in the inner region of the manifold 2. Fuel is supplied to or exhausted from the flow fields 15 through the inlet/outlet ports 18 located on two opposing coroners of the manifold 2 at the outer beveled edge 23. The inlet/outlet ports 18 include tubes 18 embedded into reinforcements 17 designed to structurally support the tubes 18. The tubes 18 interconnect the inner through channels 16 with the outer fuel supply/exhaust plumbing (not shown). The location of the tube opening 19 in the through channel 16 is best shown in FIG. 3.

When fuel enters into the manifold 2 through channel 16, it is further distributed across the flow field 15. Those skilled in the fuel cell art will appreciate that various flow field types may be used for distributing the fuel at the desired fluid flow properties. These flow fields include and are not limited to channels in different configurations, corrugated, porous or perforated plates, meshes, screens, beam structures, or the like. The flow field 15 shown in FIG. 3 has crisscrossed channels 20 that intersect at 90° and create posts 22 to structurally support anode current collector plates 3. In addition, the flow field 15 provides a plenum for water droplets to form, grow, and flow under gravity, where such strategy is applicable for liquid water removal. However, a wicking media (not shown) may also be disposed within the flow field for preventing anode flooding. In another embodiment the manifold 2 may have an open and quite simple flow field 15 that consists of the structural beams.

The central fuel manifold 2 is typically made of non conductive materials. They may include plastics made of thermoset or thermoplastic polymers, or polymer, or polymer—metal composites. However, the inlet/outlet port tubes 18a in addition to polymers, they may also be made of metals or metal alloys. The material selection is primarily based on the material resistance to the mechanical, thermal, and chemical stresses present in the operational fuel cell. In addition, an important factor for choosing a proper material is compatibility with the adhesive used for bonding the anode plate 3 and MEA 4 to manifold 2. Preferably the manifold 2 and adhesive are made of the same polymer type.

The manifold 2 can be produced by utilizing various processes known for the manufacturing of plastics and plastic composites. They may include but are not limited to injection molding, thermoforming, casting, compression molding, and transfer molding. For example, using molding process the fuel manifold 2 can be produced by a single manufacturing step to final dimensions with all features as designed.

The module 1 has two anode collector plates 3 placed on each face of the manifold 2. The anode collector plates 3 are designed to conduct current and transport the fuel from the flow field 15 to the MEA 4 anode catalyst. Anode current collector plates 3 may consist of two flat rectangular components. The first 3a component is an electrically conductive open structure layer made of corrosion resistant materials such as metals, metal alloys, or carbon based composites. They may include porous or perforated plates, screens, or meshes. The second component 3b is placed over layer 3a on the anode plate surface 3 facing the MEA 4 as shown in FIG. 2. This layer may be made of a flexible graphite material. The graphite layer 3b is bonded to the first one 3a with a conductive adhesive. The surface area of the graphite layer 3b is typically the same as the size gas diffusion layers in of the MEA 4. The purpose of the graphite layer 3b is to improve the electrical contact between the anode current collector plate 3 and MEA 4 and to increase the corrosion resistance of the plate 3a.

The components of the anode current collector plate may be manufactured form a commercially available materials such as SS 316 and Grafoil®. The anode plate 3 manufacturing procedure includes simple steps such as cutting, cleaning, chemical etching, bonding, and painting. For example, the pieces from a perforated metal plate and Grafoil® are first cut to the desired sizes. Then the metal plates are cleaned in ultrasonic bath, and ten chemically etched. An eclectically conductive adhesive is coated over the metal plate and the Grafoil® layer 3b is positioned over it. The adhesive may be applied by brushing, spraying, or screen printing. The assembly is compressed by clamping and placed at temperature to cure. Bonding process may be done in a heated press as well, or by any other means that involve compression and temperature control. When bonded, Grafoil® is stamped with a tooling that has pins arranged in the same pattern as the openings in the perforated plate 3a. The pins have diameter smaller than the openings in the plate 3a and are able to push and cut the Grafoil® trough the openings. The final step in the anode plate 3 manufacturing is painting of the plate 3a. In this step Grafoil® is first masked by a tape and then the rest of the metal plate 3a is painted with a corrosion resistant paint.

The anode collector plates 3 are inserted into the manifold recess 14 and glued to it. The recess 14 has the same height as the anode plate 3 thicknesses such that the mounted anode plate 3 creates a flat face with the manifold 2. The anode plate 3 is affixed to the manifold by gluing three edges to the recess 14. The fourth side of the anode plate 3 positioned over wider recessed surface is sealed with the adhesive. An adhesive bead is place over this surface and the anode plate 3 is embedded into it. The excess of adhesive bead penetrates through the plate 3 openings thereby creating the seal between the anode 3 plate and the manifold 2. The adhesive is removed from the anode top surface before the whole anode plates/manifold assembly is compressed and left to cure. When mounted, one side of the anode plate 3 surpasses the manifold 2 edge for electrical wiring.

The MEAs may be obtained commercially from various vendors or they may be made in-house from the similar materials or materials that have the same function. They may be prepared by various methods known in art for manufacturing MEAs for low or high temperature PEM fuel cells. MEAs 4 consist of ion exchange membrane 4a coated with electrode catalyst layers (not shown) and gas diffusion layers (GDLs) 4b that may or may not be attached to the coated membrane. In particular the MEAs 4 used in this invention have GDLs 4b attached to its opposing faces. The active area of MEA 4 coincides with the electrode area. However, GDLs 4b may have the same size as the electrodes or they can be slightly larger than the electrodes. The active area of MEA 4 is surrounded with uncoated membrane. In the preferred embodiment the membrane surface facing the anode current collector plate 3 is used to seal the hydrogen manifold 2. The membrane may be wide as much as it is needed to get a reliable sealing.

To seal the hydrogen manifold 2 with the MEA 4, it is bonded to the manifold after the anode plate 3 has been mounted. The MEA 4 is bonded with a thin layer of adhesive applied onto the flat surface 13 of the manifold 2 and the anode plate 3 in the recessed area 14. One MEA 4 is positioned at the time over the manifold/anode plate assembly such that the anode GDL 4b overlaps Grafoil® 3b while the uncoated membrane of the MEA 4 is laid over the area coated with adhesive. When both MEAs 4 are in place, the whole assembly is compressed and may be exposed to temperature to complete the adhesive setting. In the preferred embodiment both the manifold 2 and adhesive contain the same base polymer in order to enhance bonding and the manifold 2 sealing. In the preferred embodiment the adhesive can be applied using brushing, spraying, or screen printing, or any other deposition technique that enables to control the adhesive layer thickness and width.

To complete the Sym-cell module 2, cathode current collector plates 5 are placed on the opposing faces of the rest of the assembly. The plates 5 are designed to conduct current and distribute the oxidant to the MEA 4 cathode catalyst. The cathode current collector plates 5 may consist of two flat rectangular components similar to the anode plates 3. The first plate 5a may be a porous or perforated metal plate, screen, or mesh, made of an electrically conductive corrosion resistant metal or metal alloy. On the surface facing the MEA 4 cathode side the second component 5b is placed over the plate 5a. This layer 5b is typically made of a flexible graphite based material. The area of the graphite layer 5b is the same as the cathode GDL 4b. The purpose of the graphite layer 5b is to improve the electrical contact between the cathode plate 5 and MEA 4 and to increase the corrosion resistance of the metal plate 5a in contact with the MEA 4.

The cathode plate 5 is typically manufactured form a commercially available materials such as perforate stainless steel plate and flexible graphite foil Grafoil®. In the preferred embodiment the cathode plate 5 manufacturing procedure includes cutting, drilling, cleaning, chemical etching, bonding, perforation, and painting. For example, two pieces of a metal plate and two pieces of a graphite foil are first cut to the required sizes. Four holes are then drilled at the corners of each metal plate 5a. The plates are then cleaned in ultrasonic bath, and after that chemically etched. Electrically conductive adhesive is coated over the etched metal plate before Grafoil® 5b is positioned. The assembly is compressed by clamping and placed at temperature to cure. Bonding process may be done by a heated press, or by any other means that involve compression and temperature control. When bonded, Grafoil® is perforated with a tooling that has pins arranged in the same pattern as the openings in the plate 5a. The pins have smaller diameter than the openings of the perforated plate 5a thereby when the tooling and the plate 5 are compressed, the pins push and cut the Grafoil® 5b trough the openings in the plate 5a. The final step in the cathode plate manufacturing includes painting of the plate 5a not covered with the graphite layer 5b. Grafoil® 5b is first masked by a tape and then the metal plate is painted with a corrosion resistant paint.

When dried, the cathode plates 5 are assembled with the rest of the module with bolts 6 and nuts 7. Minimum four bolts 6 are used to keep the whole module intact. Plastic shrink tubes 12 are placed over bolts 6 before they are locked in with nuts 7 to keep both anode and cathode sides of each cell and two fuel cells 9 themselves electrically insolated. In addition, plastic washers 8a are used with the same purpose. To keep the compression in the stack unchanged the lock-in washers 8b are placed between plastic washers 8a and the cathode plates 5 of each fuel cell 9. The bolts 6 are tightening with nuts 7 to the level that provides a good electrical conductivity and mechanical strength to the entire Sym-Cell module 2. When assembled the cathode plates 5 surpass the rest of the module edge to attach the electrical wiring.

Sym-cell modules 2 may be stacked in various manners to get a fuel cell with a higher power output. For example, they may be arranged in an array where the individual modules 2 are attached to a structurally supportive light weight frame without being in a direct contact. In another embodiment the Sym-cell module 1 arrangement may include the stacking of the individual modules 2 into a fuel cell stack where the modules 2 are kept apart with an electrically non conductive open structure separator. The modules 2 are integrated into the stack also with a light weight supporting frame. Still another embodiment of the module 2 stacking may include a planar arrangement where the individual modules 2 are placed side by side in one plane. They may be incorporated into a planar module with a structurally supporting light weight frame as well. However, in any of the module arrangements described, the hydrogen supply still is external via existing inlets and outlets in the fuel manifold 2. In addition oxygen from air is supply through the open structure of the cathode plate 5.

When placed in fuel cell, the hydrogen gas approaches anode catalyst while oxygen approaches the cathode catalyst of the MEA 4. Protons formed on the anode catalyst are conducted through the ion exchange membrane 4a to the cathode catalyst where they combine with the reduced oxygen and generate water, electrical current and heat. Hydrogen coming into the tightly sealed manifold 2 is distributed through the flow field 15 across the MEA 4 anode surface. The flow of hydrogen in the module 2 may be trough flow, or dead ended with the periodic purge since the hydrogen exhaust contains mostly water vapor. The transfer of oxygen from air occurs via convection through the open cathode structure.

The Sym-cell module 1 may operate in wide range of temperature, pressure, relative humidity, and flow rates. For example Sym-Cell 1 operates as low temperature PEM fuel cell if Nafion® type polymer electrolyte membrane is used as an ion exchange membrane for making MEAs 4. However, Sym-Cell 1 becomes a high temperature PEM fuel cell if the MEA 4 includes an appropriate high temperature proton exchange membrane. According to the temperature range used some other materials may be accordingly selected. They materials may include the fuel manifold 2 material, sealing adhesive, electro conductive bonding adhesive, and corrosion resistant paint.

This is an example of the Sym-Cell operation that demonstrates the scope of this invention. It shows the performance of a Sym-Cell module when it operates at ambient temperature and pressure with a passive reactant supply. No active humidification or cooling is provided during the module operation.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fuel cell module comprising;
a first fuel cell,
a second fuel cell, and
a fuel manifold plate connected to each of said first and second fuel cells arranged in mirror symmetry with respect to said fuel manifold plate.

2. A fuel cell module as set forth in claim 1 wherein each said first and second plate includes an anode current collector plate, a membrane electrode assembly, and a cathode current collector plate.

3. A fuel cell module as set forth in claim 2 wherein each said first and second fuel cells present opposing faces with said fuel manifold plate connected to said opposing faces of said first and second fuel cells.
